(19) United States
(12) Patent Application Publication
(10) Pub. No.: US 2010/0108621 A1
(43) Pub. Date: May 6, 2010

(54) SELF-CONTAINED PARTICLE SEPARATOR DEVICE

(76) Inventor: Gafur Zainiev, West Bloomfield, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/535,318

(22) Filed: Aug. 4, 2009

Related U.S. Application Data
(60) Provisional application No. 61/085,954, filed on Aug. 4, 2008.

(51) Int. Cl. B01D 63/04; B01D 43/00

(52) U.S. Cl. 210/808; 210/542; 210/498

(57) ABSTRACT

A concentrator of particles dissolved or suspended in a liquid includes a top surface having a hole array therethrough and a bottom surface fused to the top surface to define an intermediate volume accessed only through the hole array. A concentrator of particles dissolved or suspended in a liquid is also provided that has an inner channel and an exterior surface and a tube having a hole array providing liquid communication between the inner channel and the exterior surface. A liquid-impermeable sheath surrounds the hole array and forms a seal to the exterior surface to define a volume between said sheath and the exterior surface. A process for concentrating particles from a liquid with these concentrators is also provided.

### RELATED APPLICATIONS

This application claims priority benefit of U.S. Provisional Application Ser. No. 61/085,954 filed Aug. 4, 2008; the contents of which are hereby incorporated by reference.

### FIELD OF THE INVENTION

The present invention in general relates to a self-contained device for concentrating particulate dissolved or suspended in a liquid on a device surface as a function of particle size and/or flexibility and in particular to a device that spontaneously draws liquid away from the concentrating particles on the device surface with an equilibrium interaction of capillary draw and air equilibrium to provide a controlled and reproducible rate of concentration.

### BACKGROUND OF THE INVENTION

There are numerous instances when detection of particulate within a liquid would be of considerable value in fields as far ranging as medical diagnosis, water quality, and material characterization. Unfortunately, concentration of particulate from a liquid has practically been difficult to perform without resort to laboratory facilities. While syringe luer filters provide for the prospect of field concentration of particulate from a liquid onto a filter cartridge, subsequent resolvation and use of the concentrated particles from such a syringe filter requires appreciable equipment and a degree of technical skill. Additionally, syringe filters exert dynamic and uncontrollable pressure on the liquid sample to force the same through the syringe filter and in the process potentially compromising both the quality of the concentration and the morphology of delicate particles.

Separating particles from a liquid such as malformed erythrocytes from blood or finding parasites within water is labor intensive as a result of the need to pipette aliquots of the liquid and subsequent separation associated with amino chemistry, chromatography, sedimentation rates or other conventional separation techniques. These problems are compounded in instances where the particle of interest is found at low concentrations such that only a single such particle or a few such particles is likely to be found in any given aliquot. The effort and equipment typically required to perform a conventional such separation precludes field use of such separation thereby making field testing problematic.

Thus, there exists a need for a particle concentrator device that is simple to use and therefore amenable for field operation as well as providing a controlled and reproducible concentration process that leaves concentrated particles amenable to collection and subsequent use.

### SUMMARY OF THE INVENTION

A concentrator of particles dissolved or suspended in a liquid includes a top surface having a hole array therethrough and a bottom surface fused to the top surface to define an intermediate volume accessed only through the hole array. A concentrator of particles dissolved or suspended in a liquid is also provided that has an inner channel and an exterior surface and a tube having a hole array providing liquid communication between the inner channel and the exterior surface. A liquid-impermeable sheath surrounds the hole array and forms a seal to the exterior surface to define a volume between said sheath and the exterior surface. A process for concentrating particles from a liquid with these concentrators is also provided.

### BRIEF DESCRIPTION OF THE DRAWINGS

FIG. 1 is a perspective view of an inventive concentrator;

FIG. 2A is a longitudinal cross section of the concentrator of FIG. 1 along the plane 2-2;

FIG. 2B depicts the addition of a liquid droplet to an inventive concentrator as depicted in FIG. 2A;

FIG. 2C depicts the concentration of particles from within the liquid droplet and the disposition of the droplet liquid after concentration has occurred on the inventive concentrator as depicted in FIG. 2A;

FIG. 3A is a longitudinal cross section of an alternative embodiment of an inventive concentrator;

FIG. 3B depicts the addition of a liquid droplet to an inventive concentrator as depicted in FIG. 3A;

FIG. 3C depicts the concentration of particles from within the liquid droplet and the disposition of the droplet liquid after concentration has occurred on the inventive concentrator as depicted in FIG. 3A;

FIG. 4A is a longitudinal cross-sectional view of a tube form of an inventive concentrator;

FIG. 4B is a transverse cross-sectional view of a tube form of an inventive concentrator of FIG. 4A along plane A-A;

FIG. 4C is a longitudinal cross-sectional view of a tube form of an inventive concentrator through the liquid-impervious sheath of FIG. 4A;

FIGS. 5A-5E depict sequential steps in concentration of a large reservoir volume of dilute suspension with the concentrator of FIGS. 4A-4C;

FIGS. 6A-6E depict sequential steps in operation of an inventive self-contained particle separator device based on an inventive concentrator of FIG. 1, while FIGS. 6F and 6G represent alternate separation results obtained for no target and a target substance respectively;

FIG. 7A is an exploded view of an inventive device of FIGS. 6A-6E within a housing providing for measured and sequential step performance;

FIG. 7B is a cross-sectional view of an inventive device of FIGS. 6A-6E depicted in transverse cross section within an exemplary housing;

FIGS. 8A-8E depict sequential steps in operation of an inventive self-contained particle separator device based on an inventive concentrator as detailed with respect to the preceding figures within the housing depicted in FIGS. 7A and 7B, while FIGS. 8F and 8G represent separation results obtained for no target and a target substance, respectively; and

FIG. 9 is a perspective view of an alternate housing for measured and sequential step performance to that depicted in FIG. 7A.

### DETAILED DESCRIPTION OF THE PREFERRED EMBODIMENTS

The present invention has utility as a simple and passively operated particle concentrator operating on the principle of size exclusion. An inventive concentrator is operative to separate particulate of a limitless variety as a function of particle size and/or flexibility, such particles illustratively including eukaryotic cells, prokaryotes, cellular agglomerates, organic debris, and inorganic debris. The liquid in which the particles are dissolved or suspended is also nearly limitless with the proviso that the liquid be compatible with the concentrator materials. The present invention operates with capillary action drawing liquid into an inventive concentrator with the pressure generated internal to the concentrator acting as an equilibrating counterforce. This reliance on force equilibrium between capillary action and internal concentrator pressure provides for only a preselected quantity of liquid being drawn into a concentrator and at a preselected rate.

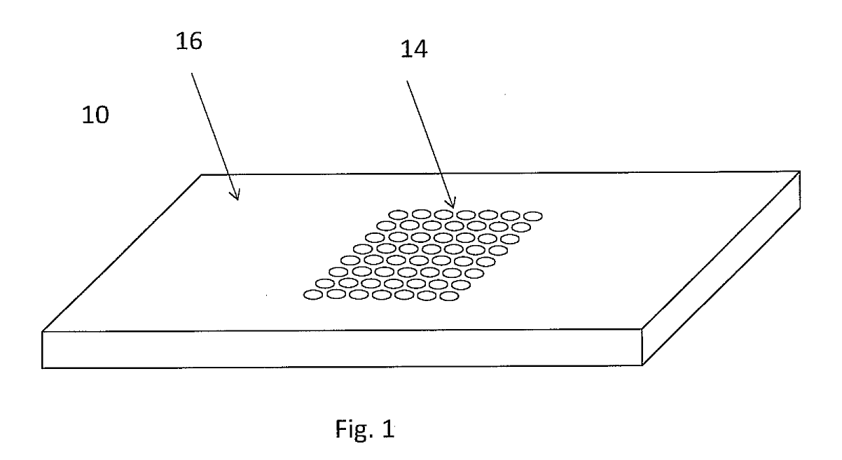

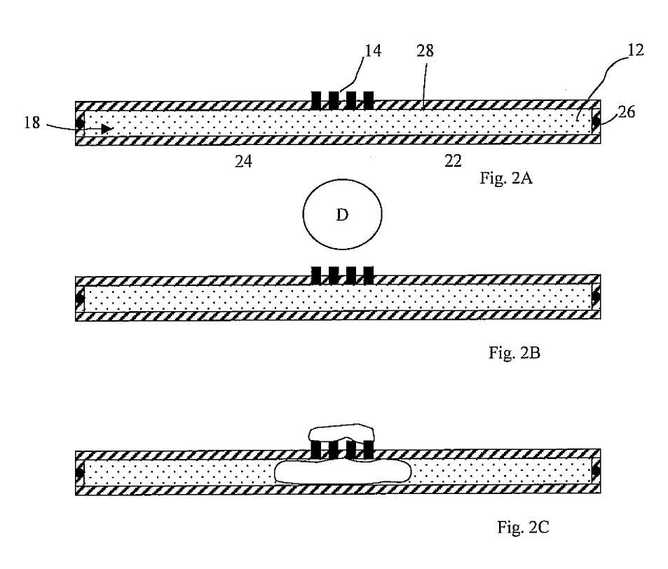

Referring now to FIGS. 1 and 2, an inventive concentrator is shown generally at 10. The concentrator 10 has an interior volume 12 isolated from the exterior of the concentrator 10 save for a hole array 14. It is appreciated that the volume 12 assumes any number of shapes and dimensions beyond the rectilinear plate form depicted in the accompanying figures. The hole array 14 is provided with holes dimensioned to exclude particle desired to be concentrated from passing therethrough.

The top surface 16 is formed from a variety of materials illustratively including glass, metal, and polymers. A hole array 14 extends to communicate with volume 12. The hole array 14 has a first array mean hole area on the top surface 16. The holes that make up the hole array 14 are each provided in a variety of shapes as measured at the top surface 16, these shapes illustratively including circular, square, hexagonal, as well as an etched or porous region allowing a liquid placed in contact therewith to percolate from top surface 16 to volume 12. Additionally, it is appreciated that each of the holes making up the hole array 14 need not have the same hole area at top surface 16 as at the boundary 28 of volume 12. By way of example, a given hole of the hole array 14 can taper to a larger or smaller area while traversing from the top surface 16 to the boundary 28 of volume 12. It is appreciated that a tapering hole particularly well suited for excluding components of a liquid from entering one of the holes of the hole array 14 the component has a size greater than the hole area top surface 16 while a hole of the hole array 14 that tapers smaller area as the hole traverses from top surface 16 to boundary 28 of volume 12 is operative to trap liquid components of intermediate size between hole area at top surface 16 and hole area at boundary 28 of volume 12. It is appreciated that a hole array 14 is readily formed by mechanical boring, laser boring, lithographic etching, or insertion of an insert into a complementary sized cutout formed in the plate 10. The insert illustratively includes a mesh, a porous membrane, or a porous gel.

The hole array 14 is formed to include a small area portion of top surface 16 having at least two holes therethrough to communicate with volume 12. The holes of array 14 are preferably segregated to an area of the top surface 16 in relationship with each other. Preferably, the holes are uniform in area with the understanding that formation inevitably leads to variation in hole area. The hole area of each hole of array 14 is preselected to preclude passage of a desired particle from the liquid and ranges from 100 nanometers to 100 microns. The hole array 14 is intended to be overlaid by a droplet D of a given liquid containing suspended or dissolved particles to be concentrated.

An inventive concentrator 10 is readily formed by blow molding glass of a polymeric material to the approximate shape of an inventive concentrator and inserting a capillary draw agent 18 to the volume 12 in instances when the dimensions of the volume 12 are too great to effectively induce capillary draw for a given liquid through contact with the opposing boundaries 28 and 22 that define the volume 12 and thereafter sealing the opening associated with the blow molding process to hermetically seal the volume 12 of the concentrator. Hole array 14 is then bored in the first surface 16 to yield the inventive concentrator 10. Alternatively, a sheet material mentioned as top surface 16 having a hole array preformed or formed after formation of concentrator 10 is then edge adhered in a spaced apart relationship with a bottom surface 24 0.1-1.0 mm thickness dimension defines wall 22 so as to in turn define the volume 12. Again, the volume 12 is filled with a capillary draw inducing agent 18 as needed. Conventional techniques of edge bonding the first surface 16 to second surface 24 illustratively include the use of contact adhesives, sonic welding, and thermal fusion. It is appreciated that an edge spacer 26 placed between first surface 16 and second surface 24 readily defines the vertical separation bounds of the volume 12.

In the event that the volume 12 has the lateral separation between walls 22 and 28 of greater than 3 millimeters, inventive concentrator 10 is unable to efficiently provide capillary flow for an aqueous based solution or suspension of particles; and a separation of greater than 2.5 millimeters is inefficient for supporting capillary draw of polar organic solvents while a separation of greater than 2 millimeters is ineffective at supporting efficient capillary draw of apolar organic solvents. In instances where the dimensions of the volume 12 are themselves too large to support efficient and reliable capillary draw of a liquid into the volume 12, a capillary draw agent 18 is provided within the volume 12 and underlying the hole array 16. A capillary draw agent 18 operative herein is effective to wick liquid from a droplet applied onto the top surface 16 overlying the hole array 14. Capillary draw agent operative herein illustratively includes nonwoven fiber mat such as cellulosic based papers; liquid swellable polymers such as in the case of water or polar organic solvents polyacrylic acids, gelatin, and polyalkylene, polystyrene granules are particularly well suited to wick away nonpolar organic solvents; closed packed spheres of glass, inorganic materials and polymers; and packed organic or inorganic granules wet by the liquid in which the particles are suspended or dissolved so as to wick the liquid through the hole array 14. Owing to the ease of processing, the capillary draw agent 18 is preferably a piece of filter paper inserted therebetween and the edges of top surface 14 and bottom surface 22 being fused together to hermetically seal the filter paper as a capillary draw agent 18 within the volume 12. The hole array 14 typically has from tens to thousands of like sized holes formed in pattern to be covered by a drop containing particles to be excluded from passing through the hole array 14.

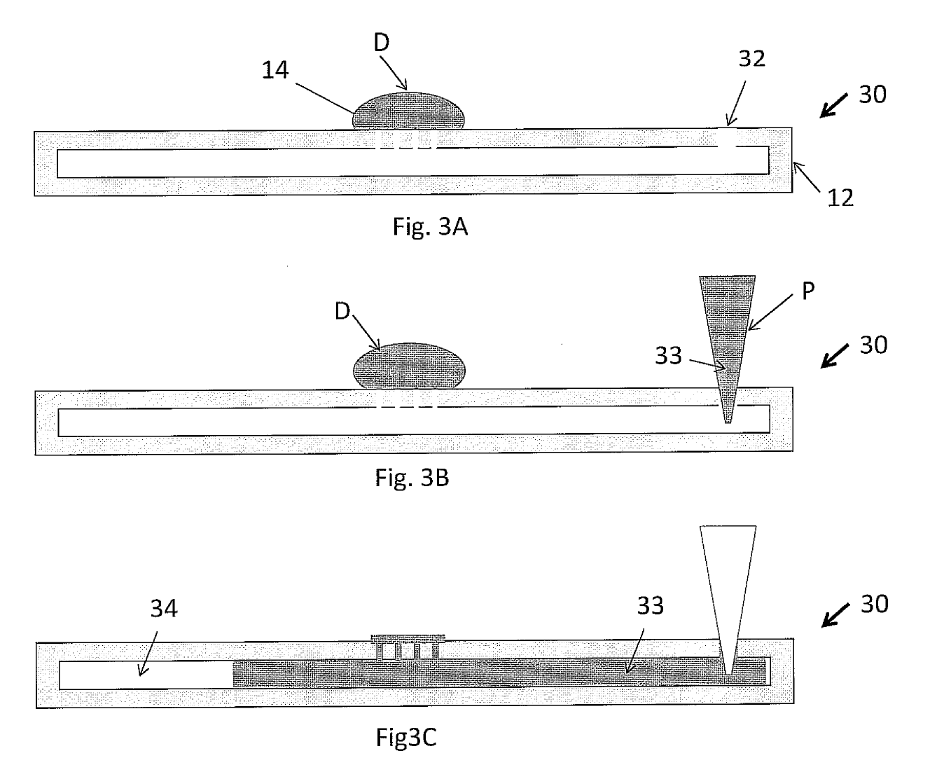

An alternative embodiment of an inventive concentrator is depicted generally at 30 with reference to FIGS. 3A-3C, where like numerals correspond to those used with respect to FIGS. 1 and 2A-2C. The concentrator 30 varies from the concentrator 10 in having an aperture 32 adapted to receive a pipette or other liquid delivery device P. It is an aspect of the present invention that the surface tension of a drop D applied to a hole array 14 can preclude capillary draw through the hole array 14 and into the volume 12 absent an external stimulus such as a surfactant to reduce drop surface tension, physical deformation of the drop D, or prewetting the hole array 14. This attribute is exploited herein to incubate a drop on top of hole array 14 for a preselected amount of time as shown in FIG. 3A. The incubation may involve reaction of the particles in the drop with a reagent to illustratively create a chemical transformation, agglomeration, or replication of a viral or cellular particle. By way of example particles decorated with antibodies binding a substance within a drop D agglomerate to form a precipitate too large to traverse the hole array 14 and remain on the top of the hole array 14. In contrast, a particle with surface exposed antibodies that is not agglomerated by a target substance passes through the hole array 14. After a preselected incubation time per FIG. 3A, an aliquot of liquid 33 is introduced to the volume 12 (FIG. 3B) to wet the underside of the hole array 14 to induce capillary draw of the drop D through array 14 and directionally away from aperture 32 until the air bubble 34 exerts a counterbalancing pressure relative to capillary draw forces, as shown in FIG. 3C. Particles that are either too large or too rigid to transit hole array 14 are isolated on the surface 16 above the array 14. In instances when the drop D is colored and that color interferes with subsequent evaluation, a bleaching agent is optionally added to the liquid 33. Other additives to the liquid 33 illustratively including antimicrobials, disinfectants, indicator reagents as to a particular substance being present, and combinations thereof.

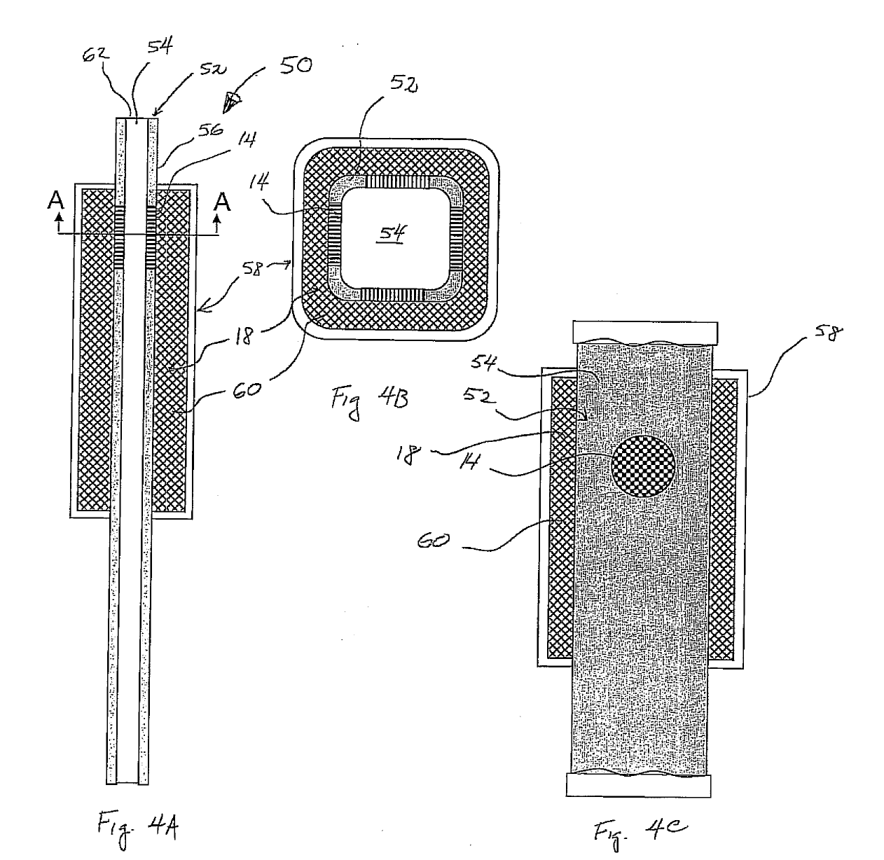

A tubular embodiment of an inventive concentrator is depicted generally at 50 with reference to FIGS. 4A-4C, where like numerals correspond to those used with respect to the aforementioned figures. The concentrator 50 has a tube 52 defining an internal channel 54. While the tube 52 is depicted in FIGS. 4A-4C as having a square cross section, it is appreciated that other cross-sectional shapes are operative herein illustratively including circular, triangular, and other regular polygonal and irregular polygonal shapes. A hole array 14 provides communication between the exterior 56 of the tube 52 and the internal channel 54. As with the aforementioned concentrators 10 and 30, the hole array 14 in addition to being a series of holes can also include a piece of mesh, porous membrane, or porous gel overlying a nonexclusionary larger cutout in the tube 52. Liquid-impermeable sheath 58 surrounds the hole array and forms a seal to the exterior surface 56 to define a volume between the sheath 58 and the exterior surface 56. The volume 60 is dimensioned to induce capillary flow of a liquid exiting the internal channel 54 by way of hole array 14 and into contact with sheath 58. Optionally, the volume 60 is filled with capillary draw inducing agent 18 as needed. As the volume 60 is sealed other than openings defined by hole array 14, only a predetermined amount of liquid is drawn into the volume 60 before the dimensions of the volume 60 capable of inducing capillary draw without resort to a capillary draw agent 18 those detailed with respect to volume 12. After a finite quantity of liquid has entered the volume 60, a counterbalancing air pressure develops as liquid exits the hole array 14 and enters the volume 60 thereby trapping a volume of air beneath the hole array and liquid. As a result, the preselected amount of concentration enhancement is exacted on a liquid.

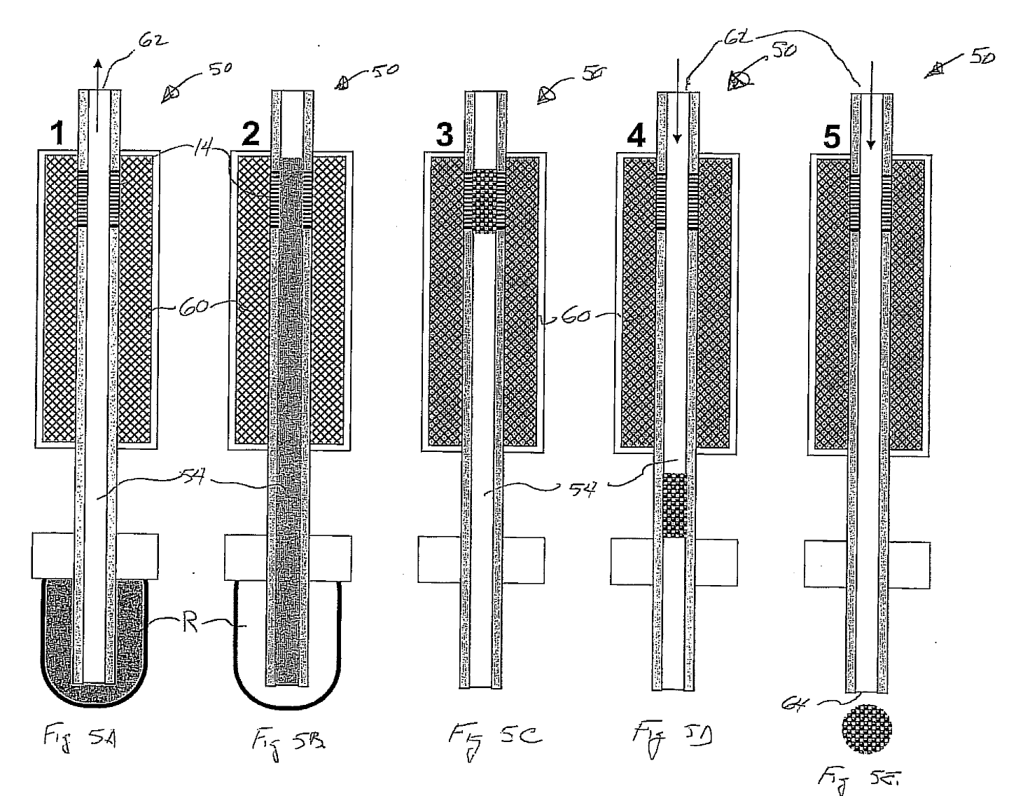

FIGS. 5A and 5B depict the operation of an inventive concentrator 50 in contact with a fluid reservoir R containing a large volume of liquid, as shown in FIG. 5A. By creating a partial vacuum on the mouth 62 of the concentrator 50 as denoted by the arrow, liquid is drawn from the reservoir R into the internal channel 54 into contact with the hole array 14, as shown in FIG. 5B. The partial vacuum drawn on the mouth 62 is provided by way of a bulb, pipette, pump or other conventional mild vacuum source. With the liquid drawn into the internal channel 54 and into contact with the hole array 14, capillary draw pulls the liquid from the internal channel 54 and into the volume 60. Preferably, the volume 60 is sized such that a preselected amount of liquid within the internal channel 54 is accommodated within the volume 60. As shown in FIG. 5C, volume 60 is wet with the liquid that previously was in reservoir R in FIG. 5A. The remaining liquid within the internal channel 54, as shown in FIG. 5C, contains particulate size excluded from passing through the hole array 14. With the liquid draw completed, a positive pressure is exerted on the mouth 62 as denoted by the downward arrow in FIG. 5D to urge the now concentrated size-excluded particles and a predefined volume of liquid down the internal channel 54. With continued positive pressure application in the mouth 62, a concentrated volume of liquid containing the size-excluded particles exits the second end 64 of the concentrator 50.

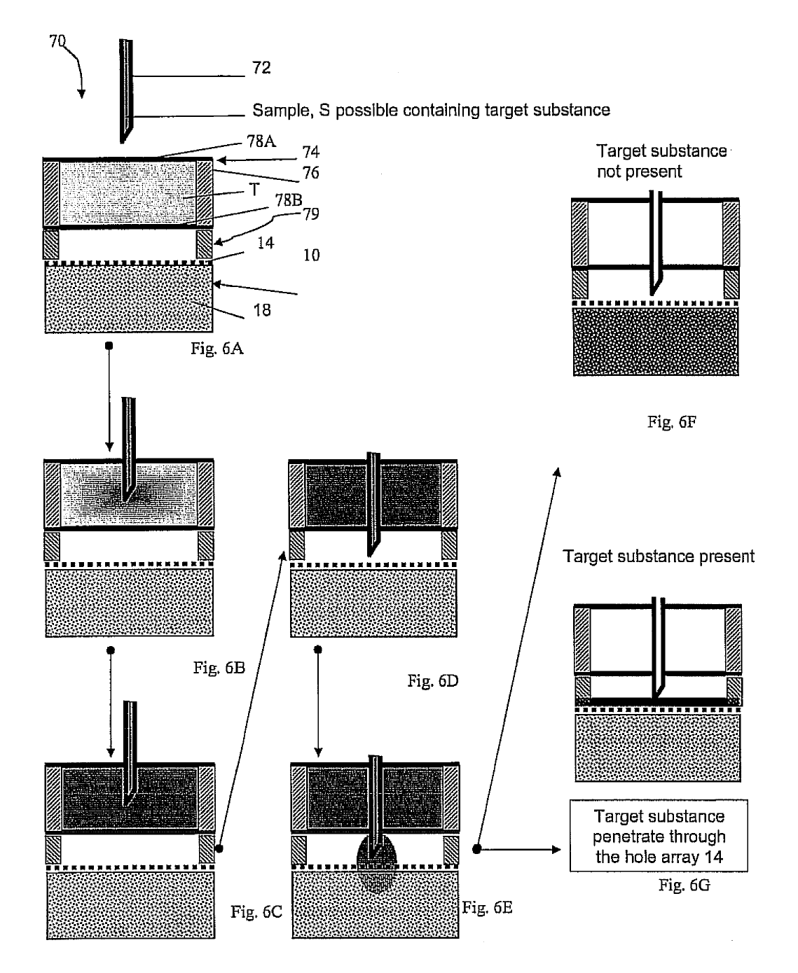

FIGS. 6A-6G depict components of an inventive device for rapid and self-contained detection of a substance by way of size exclusion within an inventive device depicted generally at 70, where like numerals correspond to those used with respect to the preceding figures. It is appreciated that while FIGS. 6A-6G depict the use of a concentrator 10, one of ordinary skill in the art would readily appreciate that a similar self-contained device is readily formed with resort to the concentrators 30 or 50. As shown in FIG. 6A, a needle 72 containing a quantity of a target substance dissolved or suspended in a liquid S is divided. The needle 72 lances a preselected volume of a solution T. The container 74 is defined by a circumferential ring 76 with the solution T bounded within spatially separated septa 78a and 78b. A ring spacer 79 optionally is included to provide a spatial separation between septum 78b and the hole array 14. The ring 76 is readily formed of a variety of materials nonreactive towards solution T for sample S and illustratively includes thermoplastics, thermosets, glass, and metal. The septa 78a and 78b are readily formed of conventional thermoplastics, elastomerics, and metal foils. The solution T provides a known amount of dilution for a sample S and is chosen based on the nature of sample S and the substance to be size excluded therefrom. By way of example, if sample S is blood containing malaria deformed red blood cells, then the solution T is by way of example a malaria parasite propagation solution. For the size exclusion of particularly small substances such as proteins or separation of a specific type of substance such as a bacteria from other like sized bacteria, the solution T includes particles that are surface decorated with antibodies binding a target substance within sample S so as to agglomerate to form a precipitate too large to reverse the holes of a concentrator 10 and thus remain on the top of the hole array 14 of the concentrator 10. In contrast, such particles with surface exposed antibodies that are not agglomerated by contact with a target substance in the sample S pass through the hole array 14 and into the volume of the concentrator 10.

FIG. 6B shows sequentially that the needle 72 punctures the upper septum 78a of container 74 to introduce the sample S into the solution T. Sample S is incubated in the solution T within container 74 for an amount of time to allow mixing therethrough and a desired reaction to induce propagation or agglomeration or other like process to occur. It is appreciated that in an incubation stage as depicted in FIG. 6C, physical conditions such as temperature, pressure and incident light exposure are optionally modified to promote a desired reaction between a target substance within sample S and the solution T. Subsequent to the incubation stage depicted in FIG. 6C, the needle 72 is driven through second septum 78b. As depicted in FIG. 6E, the liquid contents contained within the container 74 are then conveyed by the needle 72 or a hole formed in septum 78b by the needle 72 to the top of hole array 14 of the concentrator 10. As the solution contacts a capillary draw agent 18, the contents of container 74 are drawn into the volume of the concentrator 10. As shown in FIG. 6F, when none of the target substance is present in the sample S, the top of hole array 14 remains uncovered and all of the content of container 74 is now within the volume 12 of the concentrator 10. In contrast, if the sample S contained a target substance, for example malaria infected blood cells of low deformability, such cells are found decorating the top of hole array 14 while the liquid contents originally in container 74 have passed into the volume 12 of the concentrator 10. While FIGS. 6A-6G depict a single substance separation, it is appreciated that an array of containers 74 and concentrators 10 are readily provided to allow for parallel size exclusion detection of multiple substances within a sample S with variations between the nature of the solution T, characteristics of hole array 14, or combinations thereof.

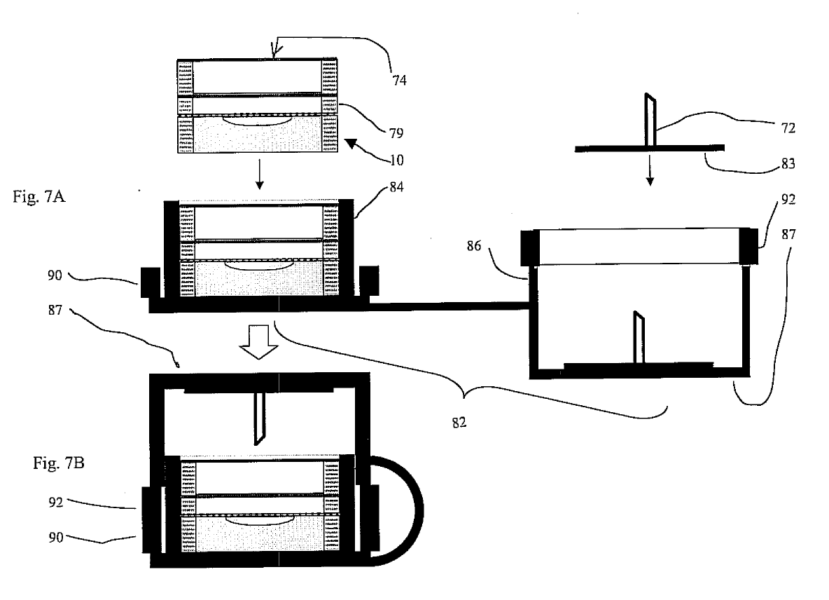

FIG. 7A depicts separation of an inventive device 70 as shown with respect to FIGS. 6A-6G within a housing and provides excessive controlled movement of a needle 72 through a container 74, where like numerals correspond to those used with respect to the preceding figures. Optionally the needle 72 has a base 83 to facilitate positioning. FIG. 7A depicts inventive device 70 as an exploded view within an exemplary housing 82. The housing 82 has a first portion 84 sized to retain a concentrator 10 in overlying alignment with a container 74 and an intermediate spacer 79 therebetween. The first portion 84 affords a barrier against the leakage of sample S or solution T therefrom. The housing 82 also has a second portion 86 adapted to receive the needle 72 such that when the first portion 84 and second portion 86 are joined, the needle 72 is in overlying alignment with the septa 78a and 78b, as depicted in FIG. 7B. A connector 88 retains the first portion 84 and the second portion 86 in a connected manner. The housing 82 is also characterized by prescored spacer flanges 90 and 92 CM the first portion 84 and the second portion 86, respectively.

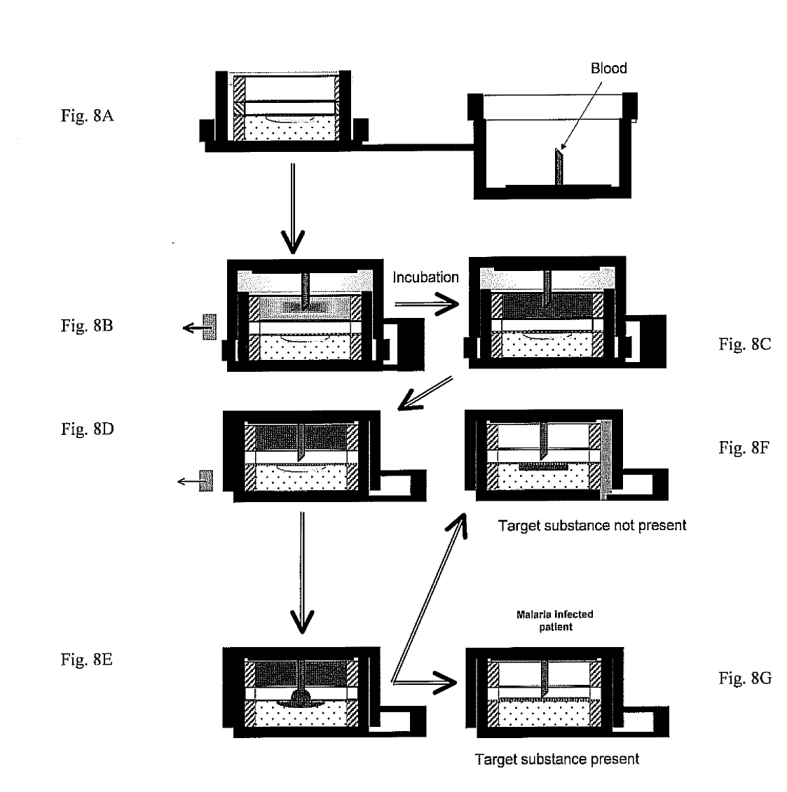

The operation of the housing 82 to provide sequential and controlled movement of the needle 72 relative to container 74 and concentrator 10 as detailed with respect to FIGS. 6A-6G is shown schematically in FIGS. 8A-8G. FIG. 8A is identical to FIG. 7A with the proviso that the needle 72 has been loaded with a sample S. In FIG. 8B, closed housing 82, as depicted in FIG. 7B, has had spacer flange 92 removed from the second housing portion 86 to allow the needle 72 to pierce the first septum 78a. An incubation phase is depicted in FIG. 8C with this spatial separation between device components. In FIG. 8D, spacer flange 90 is removed allowing needle 72 to pierce the second septum 78b. In FIG. 8E, the contents of container 74 are observed to pass through the spacer region 79 and into the concentrator 10 with the results for no target substance being found depicted in FIG. 8F while size excluded target substance is seen in FIG. 8G. It is appreciated that the instances when the needle base 83 and the housing surface 87 are transparent, visual detection as to the presence of a target substance on top of the hole array 14 occurs without the need to open the housing 82.

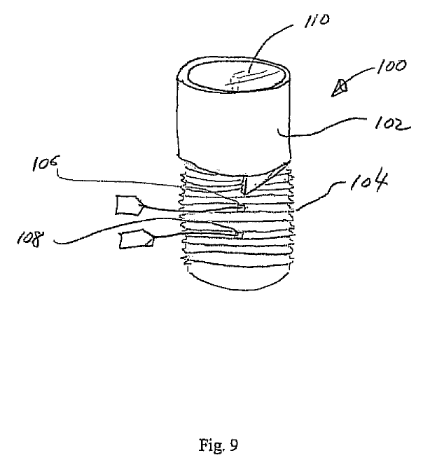

In addition to the use of spacer flanges 90 and 92 to provide sequential and controlled collapse of the housing 82 to perform the function of an inventive device 70, a similar result is performed with resort to complementary threaded first and second housing portions 102 and 104 that correspond in function to housing portions 86 and 84, respectively. Thread engagement stops 106 and 108 as depicted in FIG. 9 are sequentially removable and correspond to the spatial separations depicted in FIGS. 8B and 8D, respectively. Optionally, a transparent surface 110 affords visual observation of the top of a hole array within the housing 100 without a need to open the same and risk exposure to fluid contained therein.

### EXAMPLE 1

A sheet of Mylar having a thickness of 100 microns is subjected to laser boring to produce a close packed array of 300 holes, each having a diameter of 5 microns with the entire hole array covering a circular central area on the sheet of 3 millimeters. A duplicate sheet of

Mylar cut to the same dimensions of 1 centimeter by 3 centimeters and a slightly undersized piece of blank filter paper providing a margin of 3 millimeters there around is sandwiched between the Mylar films and the edges of the Mylar films fused to form a sealed pocket containing the filter paper. A drop of blood from a subject suspected of harboring malaria plasmodium is applied over the hole array and the blood components inclusive of normal erythrocytes are wicked into the filter paper through capillary draw under controlled rate conditions until such point as the air pressure within the housing exerts a countervailing force on blood component capillary draw into the filter paper thereby assuring the sampling of a preselected quantity of liquid, as depicted in FIGS. 2A-2C. Erythrocytes infected with malaria causing parasites are too rigid to enter holes of the hole array and are concentrated on the top surface for subsequent study or incubation by conventional techniques. The rigidity of such infected cells is known to the art. PNAS Dec. 3, 2003, 100(25), 14618-14622.

### EXAMPLE 2

The procedure of Example 1 is repeated with a drop of blood from a subject suspected of suffering from the hereditary disease sickle cell anemia with comparable isolation of abnormal erythrocytes on the top surface of an inventive concentrator overlying the hole array.

### EXAMPLE 3

The process of Example 1 is repeated with a sample of water having been incubated with an antibody specific to giardia. An agglomerate of giardia and such antibodies is collected from the top surface overlying the hole array after a droplet of the incubated water has been applied thereto.

1. A concentrator of particles dissolved or suspended in a liquid comprising:
a top surface having a hole array therethrough; and
a bottom surface, said bottom surface fused to said top surface to define an intermediate volume accessed only through the hole array.

2. The concentrator of claim 1 wherein the volume has a linear dimension between the top surface and said bottom surface that facilitates capillary draw of a liquid applied onto the hole array.

3. The concentrator of claim 2 wherein the linear dimension is less than 3 millimeters and the liquid is predominantly water.

4. The concentrator of claim 1 wherein the hole array comprises a plurality of holes having a mean hole diameter of between 2 and 20 microns and a diameter deviation of less than 20 percent.

5. The concentrator of claim 1 further comprising an aperture extending between the top surface and the volume remote from the hole array, the aperture adapted to receive an aliquot of a capillary draw inducing liquid therethrough.

6. The concentrator of claim 1 further comprising a capillary draw agent filling the volume.

7. The concentrator of claim 6 wherein said capillary draw agent is a nonwoven fiber mat.

8. The concentrator of claim 7 wherein said nonwoven fiber mat is filter paper.

9. The concentrator of claim 6 wherein said capillary draw agent is selected from the group consisting of: nonwoven fiber mat, liquid swellable polymers, close packed spheres, and granules wet by the liquid.

10. The concentrator of claim 6 further comprising an aperture extending between the top surface and the volume remote from the hole array, the aperture adapted to receive an aliquot of a capillary draw inducing liquid therethrough.

11. A concentrator of particles dissolved or suspended in a liquid comprising:
an inner channel and an exterior surface;
a tube having a hole array providing liquid communication between the inner channel and the exterior surface; and
a liquid-impermeable sheath surrounding the hole array and forming a seal to the exterior surface to define a volume between said sheath and the exterior surface.

12. The concentrator of claim 11 further comprising a capillary draw agent filling the volume.

13. The concentrator of claim 11 wherein said capillary draw agent is a nonwoven fiber mat.

14. The concentrator of claim 11 wherein said capillary draw agent is selected from the group consisting of: nonwoven fiber mat, liquid swellable polymers, close packed spheres, and granules wet by the liquid.

15. The concentrator of claim 11 wherein the volume has a linear dimension between the top surface and said bottom surface that facilitates capillary draw of a liquid applied onto the hole array.

16. The concentrator of claim 15 wherein the linear dimension is less than 3 millimeters and the liquid is predominantly water.

17. The concentrator of claim 11 wherein the hole array is a porous membrane secured to said tube.

18. A process for concentrating particles dissolved or suspended in a liquid comprising:
placing a drop of the liquid on a concentrator of claim 1;
allowing a sufficient amount of time for the liquid to be drawn by capillary action into the concentrator volume until a countervailing air pressure within the volume stops the liquid draw.

19. The process of claim 18 further comprising:
inserting an aliquot of a capillary draw inducing liquid into the concentrator volume remote from the hole array to prewet the hole array and induce the capillary action.

20. A process for concentrating particles dissolved or suspended in a liquid comprising:
pipetting the liquid into the internal channel of a concentrator of claim 11 and into contact with the hole array; and
allowing a sufficient amount of time for the liquid to be drawn by capillary action into the concentrator volume until a countervailing air pressure within the volume stops the liquid draw.
